(19) United States
(12) Patent Application Publication
(10) Pub. No.: US 2004/0158651 A1
(43) Pub. Date: Aug. 12, 2004

(54) System and method for teaming

(76) Inventors: Kan Frankie Fan, Diamond Bar, CA (US); Hav Khauv, Irvine, CA (US)

Correspondence Address: MCANDREWS HELD & MALLOY, LTD, 500 WEST MADISON STREET, SUITE 3400, CHICAGO, IL, 60661

(21) Appl. No.: 10/774,028

(22) Filed: Feb. 6, 2004

Related U.S. Application Data
(60) Provisional application No. 60/446,620, filed on Feb. 10, 2003.

(51) Int. Cl. G06F 3/00

(52) U.S. Cl. 710/1

(57) ABSTRACT

Systems and methods that provide teaming are provided. In one embodiment, a system for communicating may include, for example, a transport layer/network layer processing stack and an intermediate driver. The intermediate driver may be coupled to the transport layer/network layer processing stack via a first miniport and a second miniport. The first miniport may support teaming. The second miniport may be dedicated to a system that can offload traffic from the transport layer/network layer processing stack.

### CROSS-REFERENCE TO RELATED APPLICATION

This application makes reference to, claims priority to and claims benefit from U.S. Provisional Patent Application Serial No. 60/446,620, entitled “System and Method for Supporting Concurrent Legacy Teaming and Winsock Direct” and filed on Feb. 10, 2003.

### INCORPORATION BY REFERENCE

The above-referenced United States patent application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A host computer that employs a host protocol processing stack in its kernel space may be in communications with other remote peers via a network. A plurality of local network interface cards (NICs) may be coupled to the host protocol processing stack and to the network, thereby providing a communications interface through which packets may be transmitted or received. By using a concept known as teaming, the host computer may employ all or some of the NICs in communicating with one or more remote peers, for example, to improve throughput or to provide redundancy.

Offload systems that can expedite the processing of out-going packets or in-coming packets via dedicated hardware may provide a substantial measure of relief to the host operating system, thereby freeing processor cycles and memory bandwidth for running applications (e.g., upper layer protocol (ULP) applications). However, since the offload systems bypass the kernel space including, for example, the host protocol processing stack, offload systems are generally quite difficult to integrate with conventional teaming systems. In fact, some offload systems mandate the dissolution of teaming or the breaking up of teams. Accordingly, the offload system NIC may not be teamed with the legacy NIC team.

Further limitations and disadvantages of conventional and traditional approaches will become apparent to one of ordinary skill in the art through comparison of such systems with some aspects of the present invention as set forth in the remainder of the present application with reference to the drawings.

### BRIEF SUMMARY OF THE INVENTION

Aspects of the present invention may be found in, for example, systems and methods that provide teaming. In one embodiment, the present invention may provide a system for communications. The system may include, for example, a transport layer/network layer processing stack and an intermediate driver. The intermediate driver may be coupled to the transport layer/network layer processing stack via a first miniport and a second miniport. The first miniport may support teaming. The second miniport may be dedicated to a system that can offload traffic from the transport layer/network layer processing stack.

In another embodiment, the present invention may provide a system for communications. The system may include, for example, a first set of network interface cards (NICs) and an intermediate driver. The first set of NICs may include, for example, a second set and a third set. The second set may include, for example, a NIC that may be associated with a system that may be capable of offloading one or more connections. The third set may include, for example, one or more NICs. The intermediate driver may be coupled to the second set and to the third set and may support teaming over the second set and the third set.

In yet another embodiment, the present invention may provide a method for communicating. The method may include, for example, one or more of the following: teaming a plurality of NICs; and associating at least one NIC of the plurality of NICs with a system that is capable of offloading one or more connections.

In yet still another embodiment, the present invention may provide a method for communicating. The method may include, for example, one or more of the following: teaming a plurality of NICs of a host computer; adding an additional NIC to the host computer, the additional NIC supporting a system that is capable of offloading traffic from a host protocol processing stack; and teaming the plurality of NICs and the additional NIC.

These and other features and advantages of the present invention may be appreciated from a review of the following detailed description of the present invention, along with the accompanying figures in which like reference numerals refer to like parts throughout.

### BRIEF DESCRIPTION OF THE DRAWINGS

FIG. 1 shows a block diagram illustrating an embodiment of a system that supports teaming according to the present invention.

FIG. 2 shows a block diagram illustrating an embodiment of a system that supports teaming according to the present invention.

FIG. 3 shows a block diagram illustrating an embodiment of a system that supports teaming and a Winsock Direct (WSD) system according to the present invention.

### DETAILED DESCRIPTION OF THE INVENTION

Some aspects of the present invention may be found, for example, in systems and methods that provide teaming. Some embodiments according to the present invention may provide systems and methods for integrating legacy teaming arrangements with systems that may offload connections. Other embodiments according to the present invention may provide support to preserve teaming among network interface cards (NICs) including a NIC that is part of a system that is capable of offloading traffic. Yet other embodiments according to the present invention may provide a teaming system that supports teaming as well as remote direct memory access (RDMA) traffic, iWARP traffic or Winsock Direct (WSD) traffic.

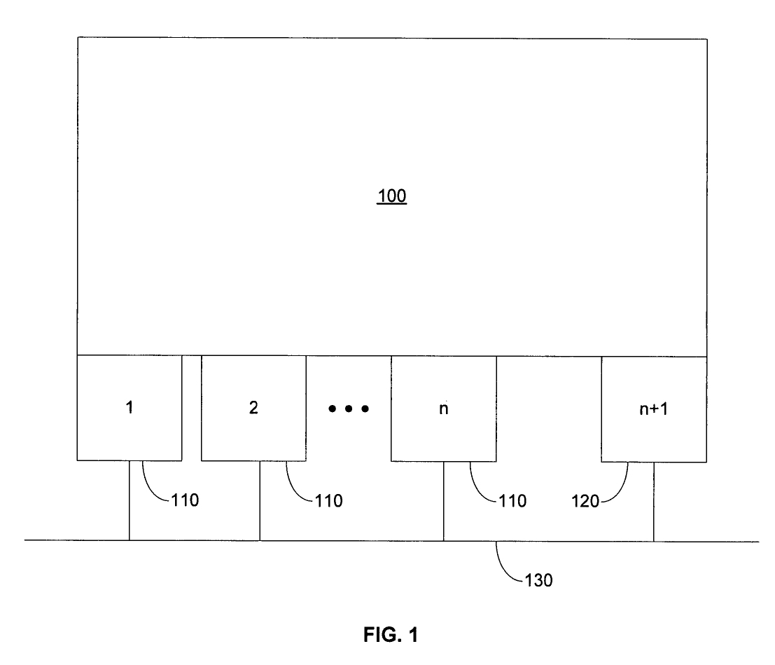

FIG. 1 shows a block diagram illustrating an embodiment of a system that supports teaming according to the present invention. A host computer 100 may be coupled to a network 130 via a plurality of NICS 110. In one embodiment, the NICS 110 may be network controllers (e.g., Ethernet controllers or network adapters) that support communications via, for example, a host protocol processing stack (not shown). The host protocol processing stack may be part of, for example, a host kernel space and may provide layered processing (e.g., transport layer processing, network layer processing or other layer processing).

The host computer 100 may be adapted to support teaming among some or all of the plurality of NICS 110. For example, the host computer 100 may run software, hardware, firmware or some combination thereof that groups (e.g., teams) multiple adapters (e.g., NICs 110) to provide additional functionality. In one embodiment, some of the NICS 110 may provide, for example, load balancing (e.g., layer 2 load balancing). Traffic may be transmitted or received over some of the NICS 110 instead of one NIC 110 to improve throughput. In another embodiment, some of NICS 110 may also provide, for example, fail-over protection (e.g., fault tolerance). If one or more of the NICS 110 fails, then one or more of the other NICS 110 may replace or otherwise may handle the load previously supported by the failed NIC 110. The connection or connections to the network need not be broken. The fail-over mechanism may even be a seemless process with respect to the host application. In yet another embodiment, some of the NICs 110 may provide, for example, virtual local access network (VLAN) functionalities. The host computer 100 may participate in different communications with other devices without having to dedicate a particular port into a particular VLAN.

The host computer 100 may also include, for example, a system (not shown) that may offload connections from the host protocol processing stack. In one embodiment, the system that may offload connections may include, for example, a kernel-bypass system. In another embodiment, the system may be added to a host computer 100 with legacy NIC teaming. The system may provide, for example, an offload engine including hardware that may expedite (e.g., accelerate) packet processing and transport between the host computer 100 and a peer computer (not shown).

The system that may offload connections may include, for example, a NIC 120. In one embodiment, the NIC 120 may be coupled to a host computer that already employs NIC teaming. The NIC 120 may receive and may transmit packets corresponding to connections managed by the system that may offload connections. The connections need not all be in an offloaded state. For example, some connections managed by the system may become candidates for offload, for example, as dynamic connection parameters (e.g., communications activity) change to warrant offloading. In another example, some connections managed by the system may become candidates for upload as circumstances dictate. In one embodiment, the NIC 120 may support all the connections managed by the system that may offload connections. Accordingly, even those connections (e.g., connections that have not been offloaded) that may be processed by the host protocol processing stack may be supported via the NIC 120. In addition, according to another embodiment, only the NIC 120 may service the connections managed by the system that may offload connections.

In integrating the system that may offload connections with legacy systems (e.g., legacy teaming systems) of the host computer 100, the host computer 100 may be adapted such that the NIC 120 may also be integrated with the legacy team of NICS 110. Accordingly, with respect to at least the legacy systems of the host computer 100, the NIC 120 may be available for teaming with one or more of the other NICS 110. Thus, the host computer 100 may communicate via a team of NICs 110 and 120 to a remote peer over the network 130. In addition, according to one embodiment, with respect to at least the system that may offload connections, the NIC 120 and one or more NICS 110 may form a team.

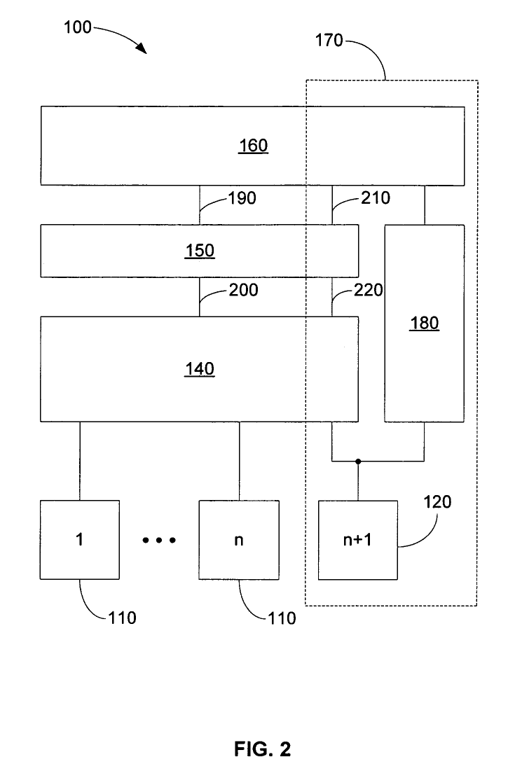

FIG. 2 shows a block diagram illustrating an embodiment of a system that supports teaming according to the present invention. Some of the components of the host computer 100 are illustrated including, for example, an intermediate driver 140, a host protocol processing stack 150 and one or more applications 160 (e.g., upper layer protocol (ULP) applications). The one or more applications 160 may be coupled, for example, to the host protocol processing stack 150 via a path 190. The host protocol processing stack 150 may be coupled to the intermediate driver 140 via a path 200. The intermediate driver 140 may be coupled to the plurality of NICs 110 via a network driver (not shown). The intermediate driver 140 may be disposed in an input/output (I/O) path and may be disposed in a control path of the host computer 100.

In addition, a system 170 that may offload connections may be integrated, at least in part, with some of the components of the host computer 100. The system 170 may include, for example, an offload path (e.g., a path that bypasses the host protocol processing stack 150) that includes, for example, the one or more applications 160, an offload system (e.g., software, hardware, firmware or combinations thereof) and a NIC 120 that supports, for example, the system 170. The system 170 may also include, for example, an upload path (e.g., a path other than an offload path) that includes, for example, the one or more applications 160, the host protocol processing stack 150, the intermediate driver 140 and the NIC 120. The upload path may include, for example, paths 190 and 200 or may include dedicated paths 210 and 220.

The intermediate driver 140 may provide team management including, for example, teaming software. In one embodiment, the intermediate driver 140 may provide an interface between the host protocol processing stack 150 and the NICs 110 and 120. The intermediate driver 140 may monitor traffic flow from the NICs 110 and 120 as well as from the host protocol processing stack 200. In one embodiment, the intermediate driver 140 may also monitor dedicated path 220 that may be part of the system 170 that may offload connections. Based upon, for example, traffic flow monitoring, the intermediate driver 140 may make teaming decisions such as, for example, the distribution of a load over some or all of the NICs 110 and 120.

In operation, offloaded traffic (i.e., traffic following the offload path) handled by the system 170 may bypass the intermediate driver 140 in passing between the one or more applications 160 and the NIC 120. In one embodiment, offloaded traffic may be processed and may be transported via the offload system 180. Traffic that is not offloaded by the system 170, but still handled by the system 170, may flow between the one or more applications 160 and the NIC 120 or possibly the NICs 110 and 120 via the upload path. In one embodiment, the traffic that is not offloaded by the system 170, but is still handled by the system 170, may flow via the host protocol processing stack 150 and the intermediate driver 140. Dedicated paths 210 and 220 may be used by the traffic that is not offloaded by the system 170, but still handled by the system 170. In one embodiment, the intermediate driver 140 may monitor traffic via, for example, dedicated path 220 and then may forward the traffic from dedicated path 220 to the NIC 120.

Teamed traffic may pass between the one or more applications 160 and the NICs 110 and 120 via a team path. The team path may include, for example, the NICs 110 and 120, the intermediate driver 140, the path 200, the host protocol processing stack 150, the path 190 and the one or more applications 160. The intermediate driver 140 may load-balance traffic over some or all of the NICs 110 and 120. In addition, the intermediate driver 140 may provide fail over procedures. Thus, if a NIC 110 (e.g., NIC 1) should fail, then another NIC 110 (e.g., NIC n) may take over for the failed NIC. The load of the failed NIC may also be load balanced over some or all of the other NICS. For example, if NIC 1 should fail, then the load of failed NIC 1 might be distributed over the other NICS (e.g., NIC 2 to NIC n+1). Furthermore, the intermediate driver 140 may team NIC 120 with some or all of the NICs 110 to provide, for example, additional VLAN functionalities.

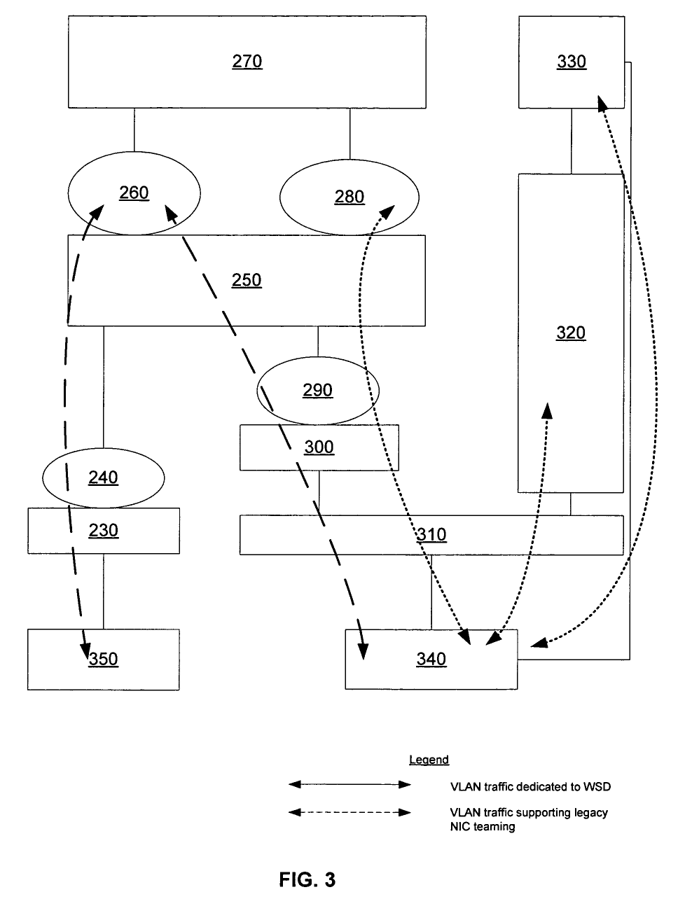

FIG. 3 shows a block diagram illustrating an embodiment of a system that supports teaming and a Winsock Direct (WSD) system according to the present invention. Although illustrated with respect to WSD, the present invention may find application with non-Windows systems (e.g., Linux systems). The WSD system may be integrated or may overlap, at least in part, with a legacy teaming system. The WSD system may include, for example, a transmission control protocol/internet protocol (TCP/IP) stack 270, an RDMA-capable-virtual (R-virtual) miniport instance 280 (e.g., VLAN=y), an intermediate driver 250, a physical miniport instance 290 (e.g., PA 1), an NDIS miniport 300, a virtual bus driver 310, an RDMA-capable NIC (RNIC) 340, a WSD/iWARP kernel mode proxy 320 and a WSD/iWARP user mode driver 330. The legacy teaming system may include, for example, the TCP/IP stack 270, a teamable-virtual (T-virtual) miniport instance 260 (e.g., VLAN=x), the intermediate driver 250, a physical miniport instance 240 (e.g., PA 2), an NDIS miniport 230 and a NIC 350.

The intermediate driver 250 may be, for example, an NDIS intermediate driver and may be aware of the WSD system. The intermediate driver 250 may be disposed both in an I/O data path and a control path of the system. The intermediate driver 250 may also concurrently support two software objects. The first software object (e.g., the T-virtual miniport instance 260) may be dedicated to teamable traffic (e.g., teamable LANs). The intermediate driver 250 may support a plurality of VLAN groups for normal layer-2 traffic in a team. Although illustrated with only one NIC branch (i.e., the physical miniport instance 240, the NDIS miniport 230 and the NIC 350), the intermediate driver 350 and the first software object may support a plurality of NIC branches. In addition, the intermediate driver 350 and the first software object may support the RNIC 340 as part of a team of NICs. The second software object (e.g., the R-virtual miniport instance 280) may be dedicated to the WSD system traffic that has passed or will pass through the TCP/IP stack 270. In one embodiment, the intermediate driver 250 may dedicate a VLAN group to the WSD traffic and may expose a network interface to be bound by the TCP/IP stack 270.

In operation, the WSD system may employ at least three traffic paths including, for example, an upload path, an offload path and a set-up/tear-down path. The upload path may include, for example, the TCP/IP stack 270, the R-virtual miniport instance 280, the intermediate driver 250, the physical miniport instance 290, the NDIS miniport 300, the virtual bus driver 310 and the RNIC 340. The offload path may include, for example, the user mode driver 330 and the RNIC 340. The set-up/tear-down path may include, for example, the kernel mode proxy 320, the virtual bus driver 310 and the RNIC 340.

If a connection has been offloaded by the WSD system, traffic may flow in either direction between the user mode driver 330 and the RNIC 340. In one embodiment, a switch layer (e.g., a WSD switch layer) and an upper layer protocol (ULP) layer including an application may be disposed in layers above the user mode driver 330 and may be coupled to the user driver 330. Thus, offloaded traffic may flow between an application and the RNIC 340 via a switch layer and the user mode driver 330.

Connections may be offloaded or uploaded according to particular circumstances. If a connection managed by the WSD system is torn down or is set up, then the kernel mode proxy 320 may be employed. For example, in setting up a connection managed by the WSD system, the user mode driver 330 may call the kernel mode proxy 320. The kernel mode proxy 320 may then communicate with the RNIC 340 via the virtual bus driver 310 to set up a connection for offload. Once the connection is set up, the kernel mode proxy may then inform the user mode driver 330 which may then transmit and receive traffic via the offload path.

Some connections may be managed by the WSD system, but may not be offloaded. Such connections may employ the upload path. The traffic managed by the WSD system, but not offloaded, may pass between the TCP/IP stack 270, the R-virtual miniport instance 280, the intermediate driver 250, the physical miniport instance 290, the NDIS miniport 300, the virtual bus driver 310 and the RNIC 340. Connections on the upload path may, at some point, be uploaded onto the offload path depending upon the circumstances. The R-virtual miniport instance 280 is dedicated for traffic managed by the WSD system. In one embodiment, the R-virtual miniport instance 280 may not be shared with the legacy teaming system.

The legacy teaming system may adjust to the presence of the WSD system. For example, the legacy team may use the RNIC 340 as part of its team. Thus, traffic may be teamed over at least two bidirectional paths. The first path is the legacy team path which includes, for example, the TCP/IP stack 270, the T-virtual miniport instance 260, the intermediate driver 250, the physical miniport instance 240, the NDIS miniport 230 and the NIC 350. The second path is an additional team path which includes, for example, the TCP/IP stack 270, the T-virtual miniport instance 260, the intermediate driver 250, the physical miniport instance 290, the NDIS miniport 300, the virtual bus driver 310 and the RNIC 340. Thus, the T-virtual LAN may use, for example, some or all of the available adapters including the NIC 350 and the RNIC 340 in a team.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A system for communications, comprising:
a transport layer/network layer processing stack; and
an intermediate driver coupled to the transport layer/network layer processing stack via a first miniport and a second miniport,
wherein the first miniport supports teaming, and
wherein the second miniport is dedicated to a system that can offload traffic from the transport layer/network layer processing stack.

2. The system according to claim 1, further comprising:
a first network interface card coupled to the intermediate driver; and
a second network interface card coupled to the intermediate driver,
wherein the second network interface card supports the system that can offload traffic from the transport layer/network layer processing stack, and
wherein the first miniport, the first network interface card and the second network interface card support teaming

3. The system according to claim 2, wherein the first network interface card comprises a plurality of network interface cards.

4. The system according to claim 2, wherein the second network interface card comprises a remote-direct-memory-access-enabled (RDMA-enabled) network interface card.

5. The system according to claim 2, wherein the second network interface card is the only network interface card that supports traffic from the system that can offload traffic from the transport layer/network layer processing stack.

6. The system according to claim 1, wherein the transport layer/network layer processing stack comprises a transmission control protocol/internet protocol (TCP/IP) stack.

7. The system according to claim 1, wherein the first miniport comprises a virtual miniport instance.

8. The system according to claim 7, wherein the virtual miniport instance comprises a virtual miniport instance adapted for teamed traffic.

9. The system according to claim 1, wherein the second miniport comprises a virtual miniport instance.

10. The system according to claim 9, wherein the virtual miniport instance comprises an RDMA-enabled virtual miniport instance.

11. The system according to claim 1, wherein the system that can offload traffic from the transport layer/network layer processing stack comprises a Winsock Direct system.

12. The system according to claim 1, wherein the second miniport supports traffic that is processed by the transport layer/network layer processing stack.

13. The system according to claim 1, wherein the second miniport supports traffic that has not been offloaded by the system that can offload traffic from the transport layer/network layer processing stack.

14. The system according to the claim 1, wherein traffic that has been offloaded by the system that can offload traffic from the transport layer/network layer processing stack bypasses the transport layer/network layer processing stack and the intermediate driver.

15. The system according to claim 1, wherein the intermediate driver supports teaming.

16. The system according to claim 1, wherein the intermediate driver comprises a network driver interface specification (NDIS) intermediate driver.

17. The system according to claim 1, wherein the intermediate driver is aware of the system that can offload traffic from the transport protocol/network protocol processing stack.

18. The system according to claim 1, wherein teaming supports load balancing.

19. The system according to claim 1, wherein teaming supports fail over.

20. The system according to claim 1, wherein teaming supports virtual network capabilities.

21. A system for communications, comprising:
a first set of network interface cards comprising a second set and a third set, the second set comprising a network interface card that is associated with a system that is capable of offloading one or more connections, the third set comprising one or more network interface cards; and
an intermediate driver coupled to the second set and to the third set, the intermediate driver supporting teaming over the second set and the third set.

22. The system according to claim 21, wherein the system that is capable of offloading one or more connections is associated only with the second set.

23. The system according to claim 21,
wherein the system that is capable of offloading one or more connections offloads a particular connection, and
wherein packets carried by the particular offloaded connection bypass the intermediate driver.

24. The system according to claim 21, wherein intermediate driver supports teaming over the first set.

25. The system according to claim 21, further comprising:
a host protocol processing stack coupled to the intermediate driver via a first virtual miniport instance and a second virtual miniport instance,
wherein the first virtual miniport instance is associated with traffic of the second set and the third set, and
wherein the second virtual miniport instance is associated solely with traffic of the third set.

26. A method for communicating, comprising:
(a) teaming a plurality of network interface cards; and
(b) associating at least one network interface card of the plurality of network interface cards with a system that is capable of offloading one or more connections.

27. The method according to claim 26, wherein (b) comprises solely associating the system that is capable of offloading one or more connections with a single network interface card of the plurality of network interface cards.

28. A method for communicating, comprising:
teaming a plurality of network interface cards of a host computer;
adding an additional network interface card to the host computer, the additional network interface card supporting a system that is capable of offloading traffic from a host protocol processing stack; and
teaming the plurality of network interface cards and the additional network interface card.

29. The method according to claim 28, further comprising:
handling packets of a particular connection only via the additional network interface card, the particular connection being maintained by the system that is capable of offloading traffic from the host protocol processing stack.

30. The method according to claim 28, wherein the additional network interface card, which has been teamed with the plurality of network interface cards, is not solely associated with the system that is capable of offloading traffic from the host protocol processing stack.

31. The method according to claim 28, further comprising:
processing packets of a particular connection via the host protocol processing stack, the particular connection not being an offloaded connection although being maintained by the system that is capable of offloading traffic from the host protocol stack.

32. The method according to claim 31, further comprising:
transmitting the processed packets only through the additional network interface card.
